(19) United States
(12) Patent Application Publication
(10) Pub. No.: US 2007/0051465 A1
(43) Pub. Date: Mar. 8, 2007

(54) Method of attaching components and article formed using same

(75) Inventors: Padraig J. Naughton, Schmitten-Dorfweil (DE); Toni Ristoski, Rochester Hills, MI (US)

Correspondence Address: DOBRUSIN & THENNISCH PC, 29 W LAWRENCE ST, SUITE 210, PONTIAC, MI, 48342, US

(73) Assignee: Dow Global Technologies, Inc.

(21) Appl. No.: 11/364,124

(22) Filed: Feb. 28, 2006

Related U.S. Application Data
(60) Provisional application No. 60/657,147, filed on Feb. 28, 2005.

(51) Int. Cl. C09J 5/00; B32B 37/12

(52) U.S. Cl. 156/305

(57) ABSTRACT

The present invention includes methods of bonding two or more components to form a unitary article. The methods involve placing the components in their final assembled position to create a joint cavity, filling the cavity with an adhesive, and curing the adhesive so that it can be handled without dissociating the components. The invention also relates to articles formed by the disclosed methods.

### CLAIM OF PRIORITY

The present application claims the benefit of U.S. provisional application No. 60/657,147, filed Feb. 28, 2005, which is hereby incorporated by reference.

### FIELD OF THE INVENTION

The present invention relates generally to attaching components and more particularly to attaching components to form articles used in automotive vehicles.

### BACKGROUND OF THE INVENTION

Historically, fabrication techniques for the manufacture of articles involved the fabrication of separate components and the joining of the components using fastening mechanisms. The fastening mechanisms typically include mechanical fasteners (e.g., rivets, screws, nuts and bolts, snap fit devices, or the like) and adhesives. However, these fastening mechanisms have drawbacks. For example, many traditional adhesives have difficultly in bonding different materials together (e.g., plastic to metal or two different types of plastic) or require several steps (e.g., priming a component, multiple applications of an adhesive, cleaning a surface, mixing adhesive compounds, or evaporating a solvent). Additional adhesive bonding limitations include long curing time, short shelf life or short open time. Adhesives may also have difficulty bonding non-planar or discontinuous surfaces or bonding multiple components sharing a common joint. Further, bonds with multiple planes may leads to smearing of the adhesive when the components are assembled together.

The inventors have recognized solutions to one or more of these problems.

### SUMMARY OF THE INVENTION

The present invention includes a method of bonding two or more components to form a unitary article. The method involves placing the components in their a proposed assembled position to create a joint cavity, filling the cavity with an adhesive and curing the adhesive so that it can be handled without dissociating the components. The invention also relates to articles formed by the disclosed methods.

### BRIEF DESCRIPTION OF THE DRAWINGS

Embodiments of the present invention will be described herein below, by way of example only, with reference to the accompanying drawing, in which:

FIGS. 1a-b show, in cross section, one embodiment of the present method where two components are placed relative to each other to form a cavity followed by filling the cavity with an adhesive;

FIG. 2a shows, in an exploded perspective, another embodiment of the present method where three components are place relative to each other. FIG. 2b shows, in close up, the three components placed to form a pair of joint cavities. FIG. 2c shows, in cross-section, the joint cavities filled with an adhesive;

FIGS. 3a-b show an exploded view and a compact view, respectively, of a front end assembly of an automobile in accordance with the present invention.

### DETAILED DESCRIPTION OF THE INVENTION

The present invention includes methods of attaching two or more components to form a bonded article. The methods include placing two or more components in their proposed assembled positions relative to one another thereby creating a joint cavity, filling the joint cavity with an adhesive, and at least partially curing the adhesive.

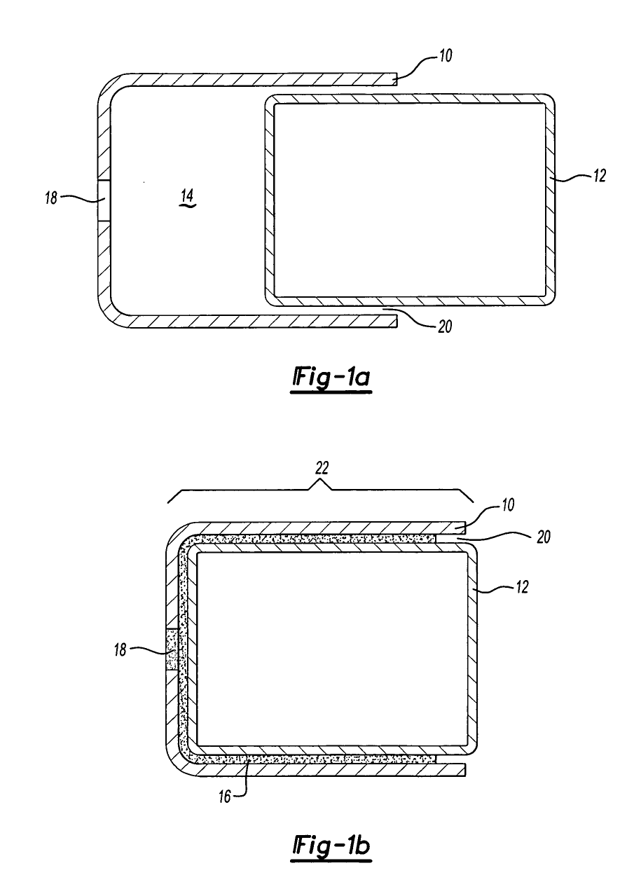

Referring to FIGS. 1a-b, the method includes placing a first component 10 and a second component 12 relative to each other to form a joint cavity 14. The components may or may not contact each other during the placing step or once they are placed. The components may be fixed together using clamps, rivets, screws, snaps or other mechanical fastening methods, to limit relative motion of the components during adhesive injection and curing. Spacing ribs or protrusions may be used on one or both of the components to maintain the joint thickness. Joint cavity 14 is then filled with an adhesive 16. The joint cavity may be filled through an access point in one of the components, e.g. aperture 18, or through an exposed edge of the cavity, e.g. edge 20. Once the cavity is at least partially filled, the adhesive is at least partially cured to form a bonded article 22.

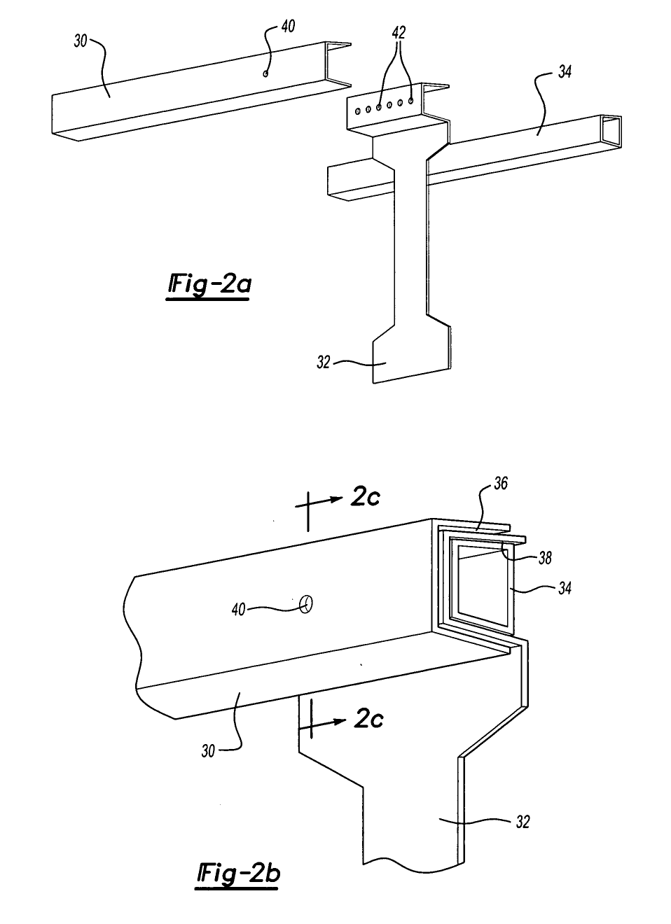

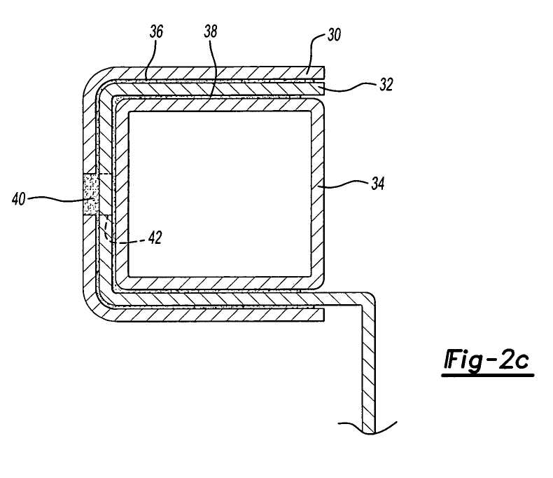

Referring to FIG. 2a-c, a method of bonding three components is shown where, a first component 30, a middle component 32, and a third component 34 are joined. A first joint cavity 36 is created by the first and middle components and a second joint cavity 38 is created by the middle and third components. The joint cavities may be filled with adhesive through a single access point 40 in the first component 30, with the adhesive traveling through one or more access points 42 (e.g., an aperture) in the middle component. Alternately, the joint cavities may be filled individually through access points in the first and third components, i.e. with no aperture in the middle component. In another embodiment, the three components cooperate to form a single joint cavity.

Placing of the components may be manually accomplished or through the use of a robot. In one preferred embodiment, the components are held in place during the filling step through the use of a securing mechanism. Any mechanism that maintains or helps maintain the size of the joint cavity between the two components is suitable. In a preferred embodiment, the securing mechanism is used until after the curing step begins. More preferably the securing mechanism is used until the adhesive is sufficiently cured to maintain the position and/or orientation of the components in the absence of the securing mechanism. Suitable securing mechanisms include those that prevent the components from moving relative to one another. For example, the components may be held in place by one or more clamps.

Alternately, the securing mechanism may be one or more forms, such as trays/fixtures, that position the components relative to one another. In another embodiment, the components are gripped by robotic arms and positioned by the robotic arms. In addition, electromagnetic energy may be used to secure the components in place. For example, static electricity may be used to secure components (e.g., plastic components) to a suitable platform or electricity may be used to magnetize metal components to secure them in place. Combinations of securing mechanism are also suitable.

Furthermore, other securing mechanisms such as mechanical fasteners, like snap-fit fasteners or friction fit fasteners, may be used to secure the components together in their relative positions before, during or after the cavity is filled or the adhesive is cured.

The one or more components may include one or more guidance mechanisms to facilitate positioning of the components. For example, a mortise-and-tenon or tongue-and-groove guides may be used to maintain the components in the desired relative position or orientation. Further, the guidance mechanisms may be used to ensure the desired volume of the joint cavity is maintained during filling or curing. For example, stops or spacers may be used to make sure the cavity does not become too small. Likewise, mechanical fasteners may be used to make sure the joint cavity does not become too large. In addition, the guidance mechanism may be used to limit the area on the components that the adhesive contacts such that over spreading of adhesive is limited.

Before, during or after formation of the joint cavity, the joint cavity is filled with an adhesive. The joint cavity may be filled through any access point to the cavity. Exemplary access points include one or more apertures or through holes in one of the components. Other access points include near an edge of one or more of the components adjacent to the joint cavity.

Any suitable filling technique may be used. In one embodiment, the adhesive can be injected into the cavity. Without limitation, injection techniques include applying positive or negative pressure to the adhesive; thus, forcing it through the access point. This can be accomplished using a syringe and plunger, a screw and extruder, combinations thereof, or the like.

In one embodiment, the access point is covered or closed after the joint cavity is filled, although this is not necessarily the case. For example, the aperture may be closed by a plug, rivet, stopper, cap, screw, patch, combinations thereof, or the like.

The curing step increases the strength of the bond between the components. The adhesive need only be cured to the extent that the bond has sufficient strength to permit handling of the bonded article.

The curing method will depend on the type of adhesive selected, and the type of adhesive selected will depend on the materials comprising the components. Curing may be accomplished upon application of adhesive via a variety of known mechanisms including heat cure, infrared cure, ultraviolet cure, chemical cure, radio frequency cure, solvent loss cure, moisture cure, shear force application cure, although the preferred adhesive requires only exposure to ambient conditions to cure. In another embodiment, the curing of the adhesive can be delayed to constitute a cure-on-demand adhesive that requires a separate operation to cause the adhesive to begin to cure. In one embodiment this is achieved by using an encapsulated curing agent that ruptures during assembly. In another embodiment this is achieved by removing a protective coating to expose the adhesive to ambient conditions.

The methods of the present invention may suitably be used to form any bonded article from two or more components. For example, the methods may be used to make articles for transportation vehicles (e.g., automobiles, boats, trains, tractors, motorcycles, or airplanes), buildings, electronics, or other manufactured products. In one preferred embodiment, the articles may be useful in or on automobiles. For example, front-end carrier assemblies, cross-car beam assemblies, tailgate/liftgate assemblies, door assemblies, water conductor assemblies, radiator end tank assemblies, oil pan assemblies, engine intake manifold assemblies, valve cover cylinder head assemblies, other engine components, other exhaust system components, exterior trim, interior trim (e.g. instrument panels), structural supports and components to automotive vehicle frames (e.g. bumpers), combinations thereof, or the like are all suitable articles that may be manufactured according to the present methods. Exemplary components may be found in application Ser. No. 10/051,417 (“Adhesively Bonded Valve Cover Cylinder Head Assembly”), Ser. No. 09/922,030 (“Adhesively Bonded Water Conductor Assembly”), Ser. No. 09/921,636 (“Adhesively Bonded Oil Pan Assembly”), and Ser. No. 09/825,721 (“Adhesively Bonded Radiator Assembly”), hereby incorporated by reference.

The present methods preferably are used to bond components made of dissimilar materials (e.g., metal to plastic, metal to wood, plastic to ceramic, a plastic to a different plastic, metal to glass, combinations thereof, or the like). Nevertheless, the present methods may also be used to bond components made of like materials.

Suitable components to be bonded may comprise a variety of structures (e.g., planar, hollow, tubular, solid, webbed, combinations thereof, or the like) without limitation. Components can be sized and shaped to compliment one another to form a joint cavity (e.g., a male component and a female component, a C-shaped surface complimented by a U-shaped surface, components that each include one of a pair of opposing surfaces that are spaced apart, combinations thereof, or the like).

Without limitation, components can be formed from filled or unfilled plastics (e.g., thermoplastics, thermosets, combinations thereof, or the like), metals (e.g., steel, aluminum, combinations thereof, or the like), woods, glass, ceramics, combinations thereof, or the like. Components may be surface treated, primed, coated or comprise additional layers of materials, combinations thereof, or the like. Suitable surface treatments include any of a number of techniques that alter the molecular state of a polymer in the component, a technique that bonds a material having the desired surface characteristic to the component, or a combination thereof. By way of specific example, one or any combination of a suitable corona treatment, flame spray treatment, or surface coating treatment may be employed. Suitable coatings include cured e-coating for metals. Suitable primers may be selected based on the selected adhesive. In one embodiment, at least one of the components is surface treated to achieve a desired surface energy. In another embodiment, only one of the components is surface treated. In another embodiment an adhesive primer is not used on a component made of plastic. In another embodiment, the assembled article comprising a finishing treatment such as painting, a decorative coating, or the like. Preferably, a class A surface finish is provided.

The first component preferably comprises a polymeric material. In a particularly preferred embodiment, at least one of the components includes a high strength thermoplastic and/or thermoset resin selected from styrenes, polyamides, polyolefins, polycarbonates, polyesters, polyvinyl esters, mixtures thereof or the like. Still more preferably they are selected from the group consisting of acrylonitrile butadiene styrene (ABS), polycarbonate/acrylonitrile/butadiene styrene, polycarbonate, polyphenylene oxide/polystyrene, polybutylene terephthalate (PBT), polyphenylene oxide, polyphenylene ether, syndiotactic polystyrene, ethylene alpha olefin, polybutylene terephthalate/polycarbonate, polyamide (e.g., nylon), polyesters, polyurethane, sheet molding compound (SMC) (e.g., polyesters, polyvinyl esters), thermoset polyurethane, polypropylene, polyethylene (e.g., high density polyethylene (HDPE)), poly acrylics, and mixtures thereof or the like. More preferably, at least one of the components comprises a polypropylene.

It is also contemplated that all of the polymeric materials above may be fiber reinforced or otherwise reinforced with ceramic, glass, polymer, natural synthetic or other fibers. According to one preferred embodiment, for reinforcement, the polymeric materials include glass fibers that are between approximately 0.1 mm and approximately 30.0 mm in length. More preferably, the fibers are between approximately 0.5 mm and approximately 20.0 mm in length. Most preferably, the fibers are between approximately 1.0 mm and approximately 5.0 mm in length. It is also contemplated that one or more fillers may be included with the polymeric materials.

The second and third components may comprise the same material or different material as the first component. Material for the second and third component may be selected from the materials discussed above with respect to the first component. Preferably, the second component comprises a metal; more preferably, the second component comprises steel; and most preferably, the second component comprises a cured e-coat.

The joint cavity, formed when the constituent components are placed relative to each other, can take any volume and shape. The cavity can be open to the environment, or it can be substantially closed with the only opening being an aperture in one of the components. Preferably, the cavity is defined by at least one surface from each of the components. More preferably, the cavity is defined by at least two surfaces from each of the components. In addition to one access point, the cavity may include one or more additional access points through which the cavity may be filled or through which air can be displaced as the volume of the cavity is filled with adhesive.

The access point can take any shape or size such that it allows adhesive to pass through to fill the cavity. Preferably, the aperture is sized and shaped to substantially conform to the size and shape of the nozzle that dispenses the adhesive into the joint cavity; however, this is not critical.

The adhesive of the present invention may optionally be a one-part or two-part adhesive that is capable of achieving a flowable state in the desired manufacturing environments for the bonded article. The adhesive may be soluble in low vapor pressure solvents (e.g., alcohols, ethers, acetone, benzenes, methanes, ethanes, combinations thereof, or the like), flowable (e.g., hot melt flowable, flowable at room temperature, and the like), foamable, combinations thereof, or the like. Preferably, the adhesive is flowable at temperatures between about −10° C. to about 240° C.; more preferably, between about −5° C. and about 160° C.; and most preferably, between about 5° C. and 30° C. Hot melt flowable adhesives should have a melting temperature substantially below the temperature at which the components to be bonded lose structural integrity.

Preferred adhesives include those that, after cure, can withstand the operating conditions of an automotive vehicle. Preferably, such an adhesive does not decompose or delaminate at temperatures of up to about 30° C., more preferably up to about 40° C., and even more preferably, greater than 60° C. Though not critical, in one embodiment, the adhesive that is employed in a joint herein has a resulting tensile strength of at least about 70 psi (about 500 kPa), more preferably about 145 psi (about 1 MPa), still more preferably about 420 psi (about 3 MPa. In some applications, such as where a structural adhesive is used, the resulting tensile strength may be as high as about 5 MPa, more preferably at least about 10 MPa), and still more preferably at least about 24 MPa.

Furthermore, the preferred adhesive is capable of withstanding prolonged exposure to the ambient operating conditions of the bonded article. For example, preferred adhesives include those that can withstand prolonged exposure to hydrocarbon materials, sodium chloride, calcium chloride, other salts, brake fluid, transmission fluid, glycol coolants, windshield washer solvents, detergents, and the like, at ambient conditions or at the above-mentioned temperatures and the pressures.

The adhesive can comprise any number of components; but preferably comprises two components. While other adhesive families are contemplated as well (e.g., urethanes, silanes, or the like), the preferred adhesive comprises one or more polyurethane based adhesives, epoxy resins, phenolic resins, polyimides, hi-bred polyimide/epoxy resin adhesives, acrylic resins, or epoxy novolac/nitrile rubber adhesives. Preferably, the adhesive is one that is flowable at room temperature and bonds low energy substrates; more preferably, the adhesive comprises a polyurethane or acrylic based adhesive; and most preferably, the adhesive is a Betamate LESA for low energy substrates such as those disclosed in U.S. Patent Nos. U.S. Pat. Nos. 6,710,145, 6,713,579, 6,713,578, 6,730,759, 6,949,603, 6,806,330 and U.S. Patent Publications 2005-0004332 and 2005-0137370, which are incorporated by reference. Other suitable adhesives include those disclosed in U.S. Pat. Nos. 5,539,070; 6,630,555; 6,632,908; and 6,706,831, which are incorporated by references.

Compositions for possible adhesives are disclosed in a patent application titled, “Amine Organoborane Complex Polymerization Initiators and Polymerizable Compositions”, PCT Publication No. WO 01/44311 A1, U.S. Ser. No. 09/466,321, herein incorporated by reference.

Adhesive may be used in the presence of primers or other adhesion promoting layers applied to one or more of the components, although preferably the adhesive is used in the absence of a primer.

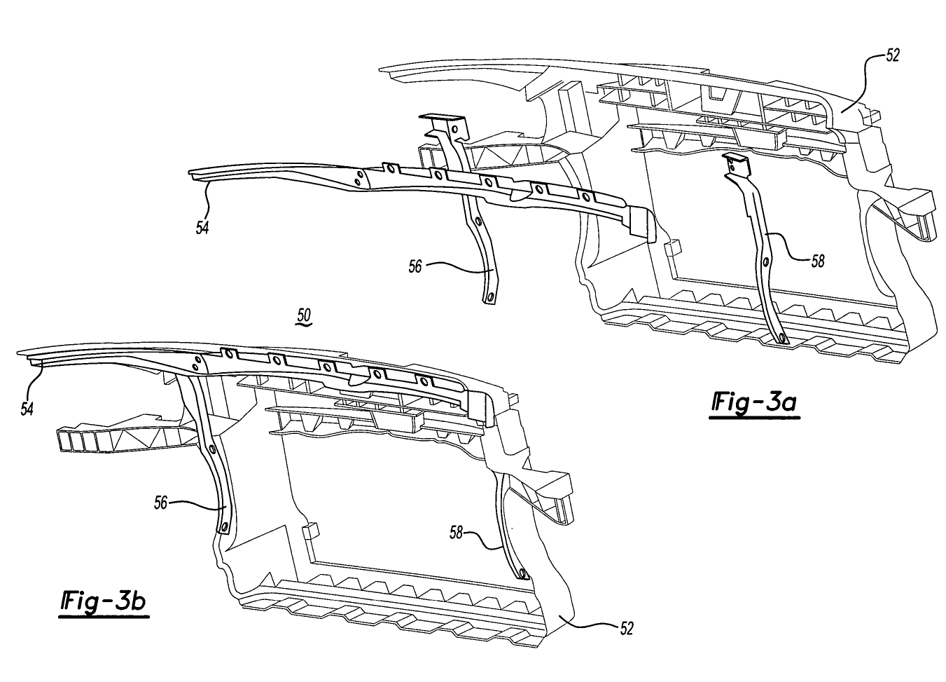

With reference to FIGS. 3a-b, one embodiment of a bonded article made according the disclosed methods is shown. A vehicle front end assembly 50 is made up of a plastic front-end carrier 52 bonded to a horizontal metal reinforcement cross-member 54. Two additional vertical metal reinforcements 56 and 58 are also bonded to the front-end carrier and the horizontal cross member.

It will be further appreciated that functions or structures of a plurality of components or steps may be combined into a single component or step, or the functions or structures of one step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

1. A method for manufacturing a transportation vehicle assembly, comprising:
holding at least a plastic component relative to a component with a securing mechanism to form a joint cavity wherein at least one access point provides access to the joint cavity;
at least partially filling the joint cavity with a flowable adhesive through the at least one access point; and
at least partially curing the adhesive.

2. The method of claim 1 wherein the access point is an aperture in at least one of the components.

3. The method of claim 1 further comprises holding at least a third component relative to the other components.

4. The method of claim 1 wherein the plastic component comprises a thermoplastic.

5. The method of claim 4 wherein the plastic component comprises a polypropylene reinforced with glass fibers.

6. The method of claim 4 wherein the metal component comprises an e-coated metal.

7. The method of claim 1 wherein the curing step comprises curing at ambient conditions.

8. The method of claim 1, wherein the adhesive is flowable at ambient conditions.

9. The method of claim 1 wherein the adhesive comprises an acrylic or polyurethane adhesive.

10. The method of claim 1 wherein the adhesive is utilized in the absence of a primer on at least the plastic components.

11. A bonded transportation vehicle assembly comprising:
at least one joint cavity located between a first plastic component and a second metal component wherein the components are held together with a securing mechanism; and
at least a partially cured adhesive that has been injected through an access point into the at least one joint cavity at ambient conditions.

12. The assembly of claim 11 wherein the first plastic component comprises a fiber filled polypropylene.

13. The assembly of claim 12 wherein the second metal component comprises an e-coated metal.

14. The assembly of claim 13 wherein the adhesive is utilized in the absence of a primer on the plastic component.

15. The assembly of claim 14 wherein the adhesive bonds components include front-end carrier assemblies, cross-car beam assemblies, tailgate/liftgate assemblies, door assemblies, water conductor assemblies, radiator end tank assemblies, oil pan assemblies, engine intake manifold assemblies, valve cover cylinder head assemblies, exhaust system components, exterior trim, interior trim, structural supports, or combinations thereof.

16. The assembly of claim 15 wherein the first component is a front end carrier and the second component is a horizontal reinforcement cross member and further comprising additional components in the form of vertical metal reinforcements.

17. The assembly of claim 11 further comprising a third component.

18. The assembly of claim 11 wherein the adhesive is flowable at ambient conditions.

19. The assembly of claim 19 wherein the adhesive is an acrylic or polyurethane adhesive.

20. A process of manufacturing a vehicle front end assembly comprising:
holding a filled, polypropylene front-end carrier and at least one horizontal steel cross-member with a securing mechanism to form at least one joint cavity wherein at least one aperture in one of the components provides access to the joint cavity;
injecting an adhesive flowable at ambient conditions through the aperture into the joint cavity; and
at least partially curing the adhesive at ambient conditions until it possesses sufficient green strength to be handled.
